(19) United States
(12) Patent Application Publication
(10) Pub. No.: US 2026/0099409 A1
(43) Pub. Date: Apr. 9, 2026

(54) CAPTURING SNAPSHOTS IN A STORAGE SYSTEM

(71) Applicant: HEWLETT PACKARD ENTERPRISE DEVELOPMENT LP, Spring, TX (US)

(72) Inventors: Xiali He, Andover, MA (US); Matthew S. Gates, Houston, TX (US); Alex Veprinsky, San Jose, CA (US); Lee L. Nelson, Boise, ID (US); Monica Jane Kinney, Boise, ID (US)

(21) Appl. No.: 18/907,897

(22) Filed: Oct. 7, 2024

(51) Int. Cl. G06F 11/14

(52) U.S. Cl. CPC G06F 11/1458; G06F 2201/84

(57) ABSTRACT

Example implementations relate to operations in a storage system. An example implementation includes receiving a write of a first data unit to a first address in a volume, and populating a first volume entry, in a base volume table, with a reference to a first version table. The example implementation also includes, in response to detecting a snapshot trigger event, generating a first snapshot table and a second version table, where the first snapshot table is a copy of the base volume table. The example implementation also includes, subsequent to generating the first snapshot table, receiving a write of a second data unit to a second address in the volume, and populating a second volume entry, in the base volume table, with a reference to a second version table.

### BACKGROUND

Computing devices may include components such as a processor, memory, caching system, and storage device. The storage device may include a hard disk drive that uses a magnetic medium to store and retrieve data blocks. Some storage systems may transfer data between different locations or devices. For example, some systems may transfer and store copies of important data for archival and recovery purposes.

### BRIEF DESCRIPTION OF THE DRAWINGS

Some implementations are described with respect to the following figures.

FIG. 1 is a schematic diagram of an example storage system, in accordance with some implementations.

FIGS. 2A-2C are illustrations of example operations, in accordance with some implementations.

FIG. 3 is an illustration of an example process, in accordance with some implementations.

FIGS. 4A-4H are illustrations of example operations, in accordance with some implementations.

FIG. 5 is an illustration of an example process, in accordance with some implementations.

FIG. 6 is an illustration of an example process, in accordance with some implementations.

FIG. 7 is a schematic diagram of an example computing device, in accordance with some implementations.

FIG. 8 is an illustration of an example process, in accordance with some implementations.

FIG. 9 is a diagram of an example machine-readable medium storing instructions in accordance with some implementations.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In some examples, a computing system may persistently store data in one or more storage devices. For example, a server may store a collection of data on a local storage array, and may also store a backup copy of the collection of data in a remote backup device. In some examples, the backup copy may be stored in a different form than the collection of data. For example, the backup copy may comprise a deduplicated representation of the collection of data. As used herein, a “storage system” can include a storage device or an array of storage devices. A storage system may also include storage controller(s) that manage(s) access of the storage device(s). A “data unit” can refer to any portion of data that can be separately identified in the storage system. In some cases, a data unit can refer to a chunk, a collection of chunks, or any other portion of data.

In some examples, a storage system may store data units in persistent storage. Persistent storage can be implemented using one or more of persistent (e.g., nonvolatile) storage device(s), such as disk-based storage device(s) (e.g., hard disk drive(s) (HDDs)), solid state device(s) (SSDs) such as flash storage device(s), or the like, or a combination thereof. As used herein, a “controller” can refer to a hardware processing circuit, which can include any or some combination of a microprocessor, a core of a multi-core microprocessor, a microcontroller, a programmable integrated circuit, a programmable gate array, a digital signal processor, or another hardware processing circuit. Alternatively, a “controller” can refer to a combination of a hardware processing circuit and machine-readable instructions (software and/or firmware) executable on the hardware processing circuit.

In some examples, a storage system may implement a logical or virtual volume as an abstraction of the persistent storage. For example, the storage system may store data units in logical addresses that are mapped to physical storage locations (e.g., in one or more persistent storage devices). Such logical addresses may be referred to as “offsets” in a volume. In some examples, the storage system may include metadata structures to store information about the stored data units. For example, a mapping table may record the logical address and the corresponding physical storage location of each data unit stored in the storage system.

In some examples, the storage system may use a metadata structure to capture a snapshot of a storage volume. As used herein, a “snapshot” is a representation of the data included in storage volume(s) (or other collection(s) of data) at a particular point in time (also referred to herein as a “snapshot time”). For example, a mapping table may be copied at various snapshot times, and the copied mapping tables may be stored for later retrieval. In such examples, each stored mapping table may represent a snapshot that captures the state of the stored data units (e.g., logical addresses and physical locations) as they existed at a corresponding snapshot time. In this manner, the snapshots may be used to reconstruct the stored data units as they existed at the various snapshot times (e.g., to recover from a failure event, for historical analysis, and so forth).

In some examples, after capturing a number of snapshots, the physical storage locations of the data units may be changed (e.g., due to defragmentation of a storage disk, failure of a storage disk, and so forth). However, in such examples, each of the snapshots may have to be updated to reflect the changed physical storage locations. For example, such updating may include transferring a relatively large number of mapping tables from persistent storage into memory, determining which mapping tables are affected by the changed physical locations, updating each affected mapping table, and transferring the updated mapping tables from memory back to persistent storage. Therefore, such updating may involve a significant amount of processing and network bandwidth.

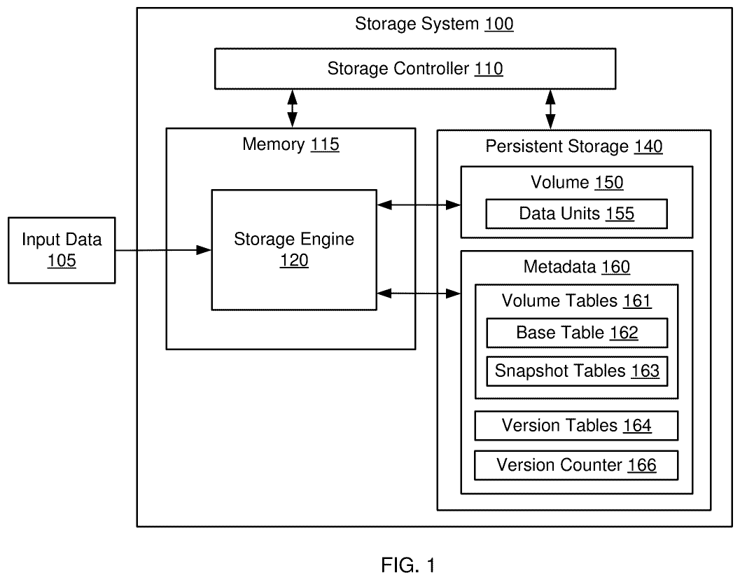

In accordance with some implementations of the present disclosure, a storage system may use metadata structures including volume tables and version tables. The entries in both the volume tables and the version tables may be indexed to different addresses (e.g., offsets) in a volume. The volume tables may include a base volume table and any number of snapshot tables. Further, each version table is associated with a different snapshot of the volume (also referred to herein as a snapshot “version” or “version number”). When a data block is written to an address, the corresponding entry of the base volume table (i.e., the entry indexed to that address) may be populated with a reference to a current version table (e.g., version one table). The corresponding entry of the version table may store a pointer to the physical location of the data block, and may also store a reference count (e.g., to indicate how many volume tables are referencing that entry of the version table). To generate a snapshot, the base volume table may be copied to create a snapshot table, and a new version table may be initialized. The snapshot may be recorded by the combination of the snapshot table and the version table associated with the same snapshot version. Subsequently, if the physical location of the data block is changed, only the version table that includes the pointer to the physical location has to be updated. Accordingly, some implementations may reduce the amount of processing and data transfer required to maintain accurate snapshots. The disclosed technique for capturing snapshots is discussed further below with reference to FIGS. 1-8.

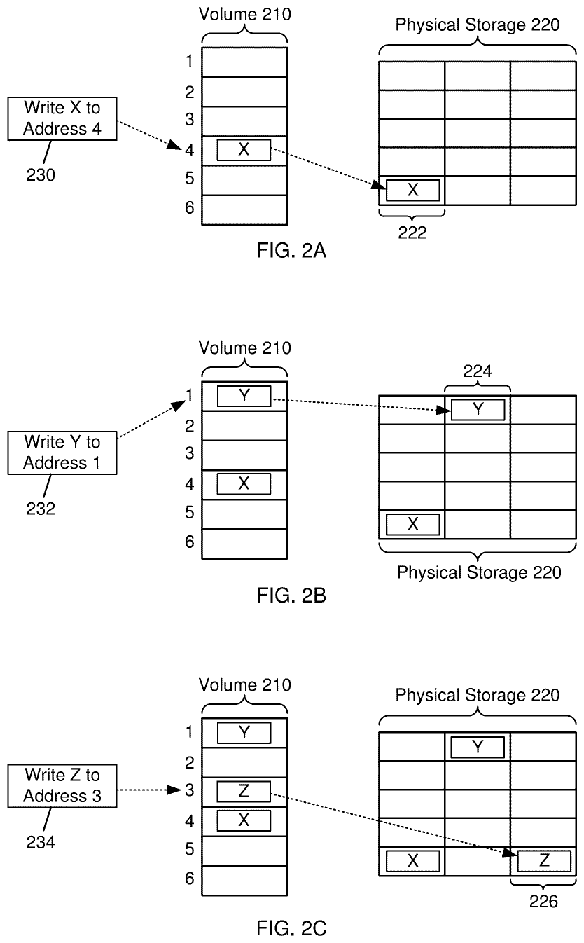

### FIGS. 1-2C—Example Storage System

FIG. 1 shows an example of a storage system 100 that includes a storage controller 110, memory 115, and persistent storage 140, in accordance with some implementations. The persistent storage 140 may include one or more non-transitory storage media such as hard disk drives (HDDs), solid state drives (SSDs), optical disks, and so forth, or a combination thereof. The memory 115 may be implemented in semiconductor memory such as random access memory (RAM). In some examples, the storage controller 110 may be implemented via hardware (e.g., electronic circuitry) or a combination of hardware and programming (e.g., comprising at least one processor and instructions executable by the at least one processor and stored on at least one machine-readable storage medium).

In some implementations, the persistent storage 140 may include a volume 150 (or multiple volumes 150). The volume 150 may be an abstraction (e.g., a logical or virtual volume) of physical storage locations of stored data units 155. For example, the volume 150 may be arranged in addresses (e.g., offsets in the volume 150) that are mapped to different physical locations (e.g., locations in different drives in an array) that store the data units 155. For example, referring now to FIG. 2A, shown is a command 230 to write a data unit “X” to an address “4” in a volume 210. As shown, the address “4” is mapped to the physical location 222 of the data unit “X” in the physical storage 220. Further, as shown in FIG. 2B, a command 232 writes a data unit “Y” to an address “1” that is mapped to a location 224 in the physical storage 220. Furthermore, as shown in FIG. 2C, a command 234 may write a data unit “Z” to an address “3” that is mapped to a location 226 in the physical storage 220.

Referring again to FIG. 1, in some implementations, the memory 115 may include a storage engine 120. As used herein, an “engine” may refer to machine-readable instructions (e.g., software instructions and/or firmware instructions stored on at least one machine-readable storage medium) executable on a hardware processing circuit. For example, the storage engine 120 may be implemented as program code that is executed by the storage controller 110 and loaded in memory 115. Further, in some implementations, the program code for the storage engine 120 may be stored in the persistent storage 140. Alternatively, an “engine” may refer to a hardware processing circuit (e.g., any or some combination of a microprocessor, a core of a multi-core microprocessor, a microcontroller, a programmable integrated circuit, a programmable gate array, a digital signal processor, or another hardware processing circuit), or a combination of a hardware processing circuit and machine-readable instructions.

In some implementations, the storage engine 120 may manage operations to add, remove, or remove data units 155 in the volume 150. For example, the storage engine 120 may receive or read the input data 105 (e.g., via a write command), and may store a copy (or multiple copies) of the received data as stored data units 155. Further, the storage engine 120 may receive requests for the stored data units 155 (e.g., via a query or read command), and in response may to retrieve and return the requested data units 155.

In some implementations, the persistent storage 140 may include metadata 160. As shown, the metadata 160 may include volume tables 161, version tables 164, and a version counter 166. The volume tables 161 and the version tables 164 may include entries that are indexed to different addresses (e.g., offsets) in the volume 150. The volume tables 161 may include a base table 162 and any number of snapshot tables 163. Further, each version table 164 may be associated with a different snapshot version of the volume 150.

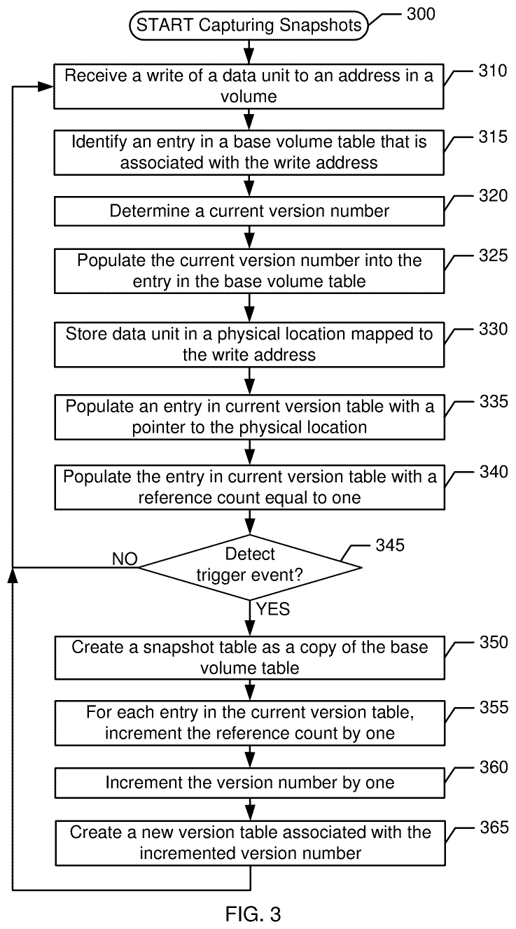

In some implementations, the version counter 166 may indicate the version number of the next following snapshot (i.e., the upcoming snapshot that is pending to be captured). For example, prior to capturing a first (i.e., initial) snapshot of the volume 150 (i.e., before any snapshots have been captured), the version counter 166 may indicate the number “1.” Further, immediately after capturing the first snapshot, the version counter 166 may be increment to indicate the number “2.” In some implementations, the metadata 160 may be used to map logical addresses and physical storage locations, and to record snapshots of the volume 150. For example, a snapshot (e.g., version one snapshot) may be recorded by the combination of the snapshot table 163 and the version table 164 of the same version (e.g., the snapshot one table 163 and the version one table 164). Example implementations of the metadata 160 are discussed further below with reference to FIGS. 3-8.

Note that, while FIG. 1 illustrates metadata elements 161, 162, 163, 164 as “tables,” implementations are not limited in this regard. For example, it is contemplated that metadata elements 161, 162, 163, 164 may be implemented using other types or forms of data structures (e.g., (e.g., relational database, object database, extensible markup language (XML) database or file, a flat file, and so forth).

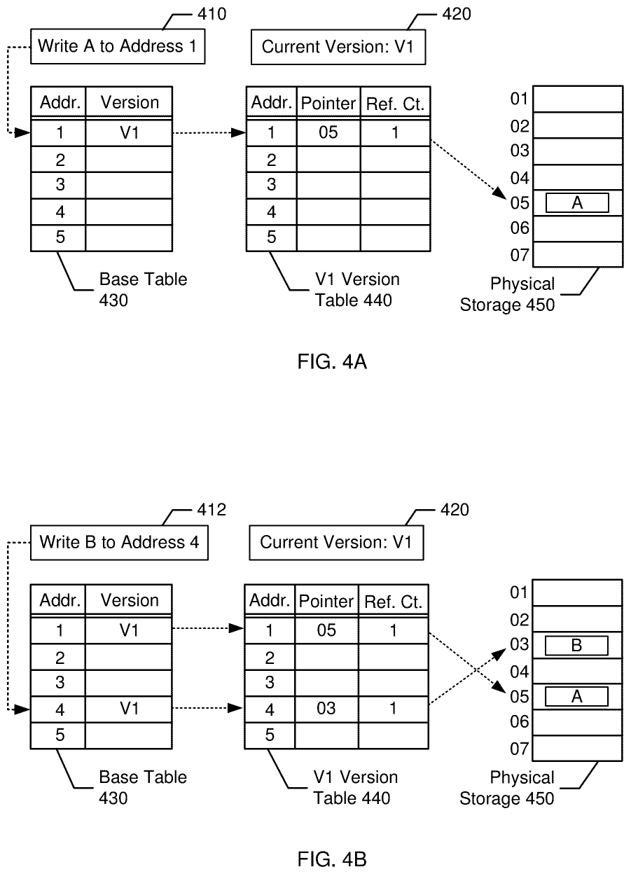

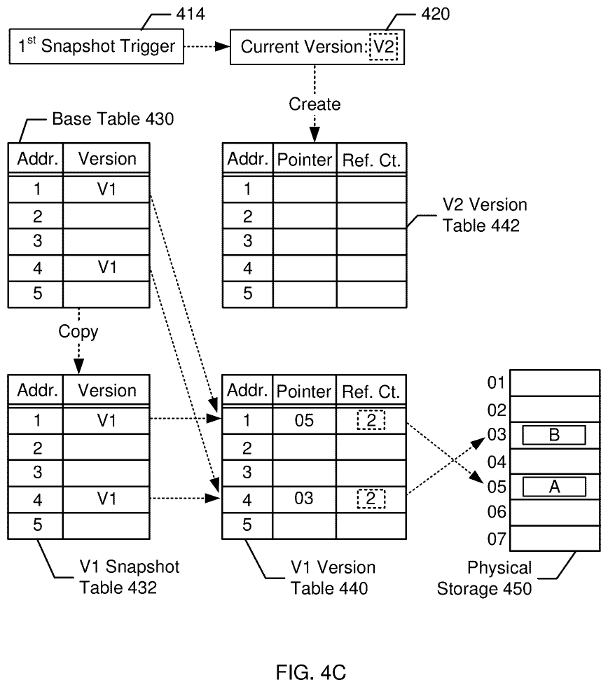

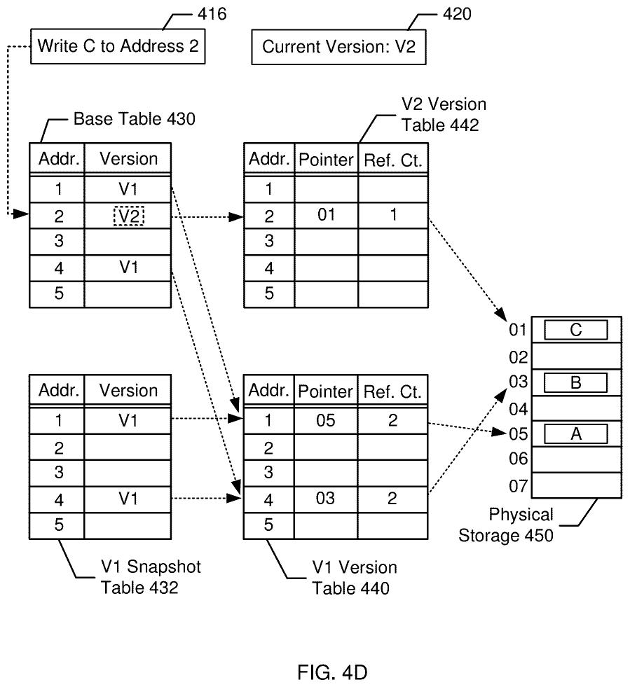

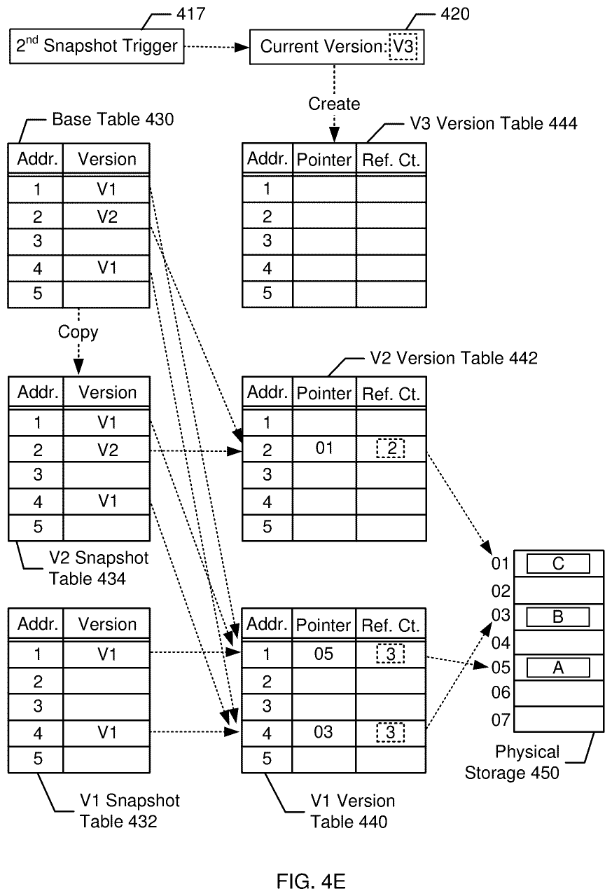

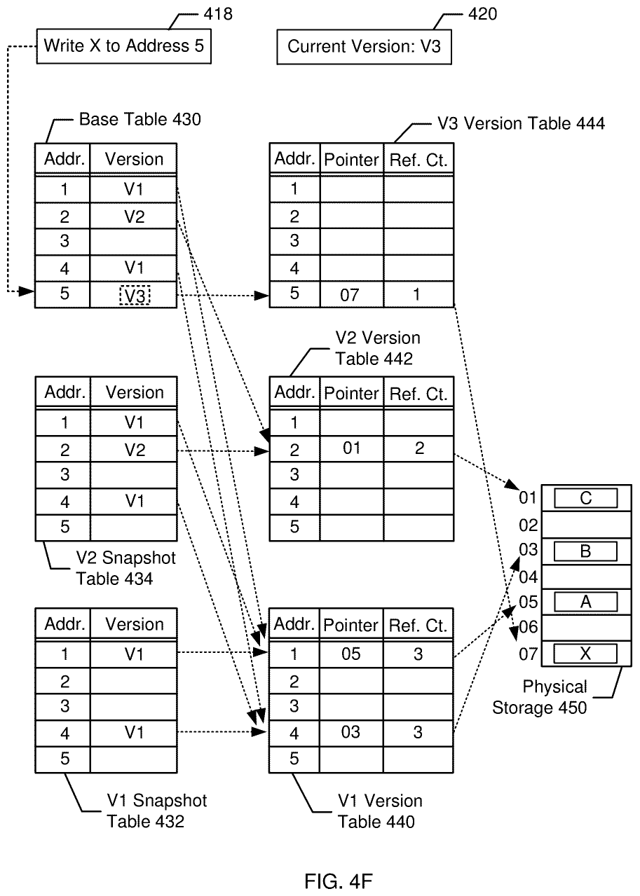

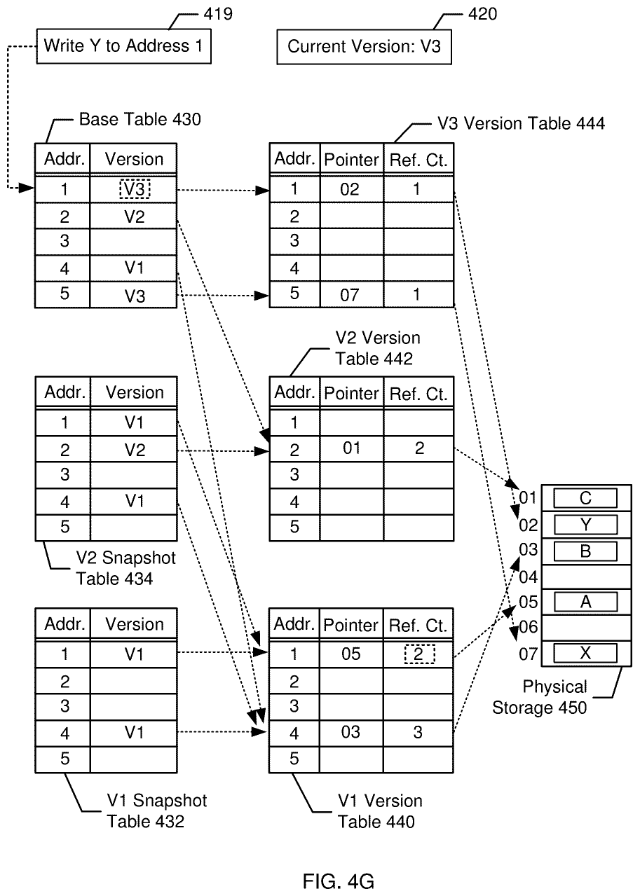

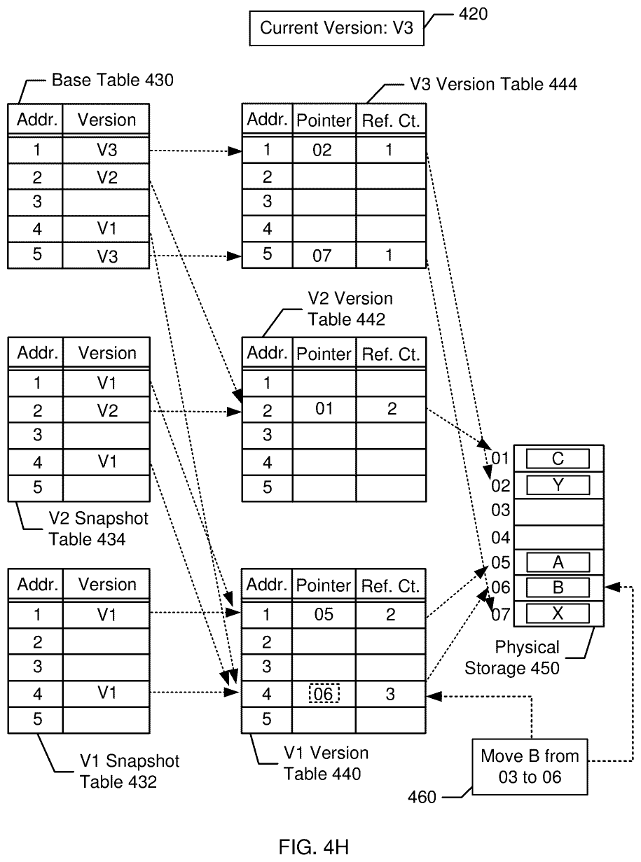

### FIGS. 3-4H—Example Process for Capturing Snapshots

FIG. 3 shows an example process 300 for capturing snapshots, in accordance with some implementations. For the sake of illustration, details of the process 300 may be described below with reference to FIGS. 4A-4H, which show examples in accordance with some implementations. However, other implementations are also possible. In some examples, the process 300 may be performed using the storage controller 110 (shown in FIG. 1). The process 300 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Referring to FIG. 3, block 310 may include receiving a write of a data unit to an address in a logical volume. Block 315 may include identifying an entry in a base volume table that is associated with the write address. Block 320 may include determining a current snapshot version number. Block 325 may include populating the snapshot version number into the entry in the base volume table.

Referring now to FIG. 4A, shown is an example in which a first write command 410 is received prior to capturing an initial snapshot of a volume. In the example shown in FIG. 4A, a controller (e.g., storage controller 110 shown in FIG. 1) receives the first write command 410 to write the data unit “A” to an address “1” in a volume (e.g., volume 150 shown in FIG. 1). In response to the write command 410, the controller reads a current version data structure 420 to determine the current snapshot version “V1.” The snapshot version “V1” may correspond to an initial (i.e., first in sequence) snapshot number, and may indicate that the initial snapshot is still pending (i.e., has not yet been captured). Further, the controller accesses a base table 430, and identifies an entry that is indexed to the write address “1” (specified in the write command 410). Further, the controller populates the identified entry of the base table 430 with an indication or identifier of the current snapshot version (e.g., “V1” or “1”).

The current version data structure 420 may correspond generally to an example implementation of the version counter 166 (shown in FIG. 1). Further, the base table 430 may correspond generally to an example implementation of the base table 162 (shown in FIG. 1). In some implementations, the base table 430 may include multiple entries, where each entry represents (or is indexed to) a different address in a volume (e.g., volume 150 shown in FIG. 1). Further, in some implementations, each entry of the base table 430 may be initially empty (i.e., not populated with any data), and may be populated when a data unit is written to the address represented by that entry. Furthermore, in some implementations, each populated entry of the base table 430 only stores an indication of a snapshot version (e.g., that was current (e.g., “V1” or “1”).

Referring again to FIG. 3, block 330 may include storing the data unit in a physical location mapped to the write address. Block 335 may include populating an entry in a current version table with a pointer to the physical location. Block 340 may include populating the entry in the current version table with a reference count equal to one.

For example, referring again to FIG. 4A, the controller stores the data unit “A” in the location “05” in physical storage 450. Further, the controller accesses the V1 version table 440 (i.e., a version table associated with the current snapshot version “V1”), and identifies the entry “1” (i.e., the entry that is indexed to the write address “1”) in the V1 version table 440. The controller populates the entry “1” of the V1 version table 440 with a pointer to the physical location “05.” As shown in FIG. 4A, the controller also populates the entry “1” of the V1 version table 440 with the reference count equal to “1.”

The V1 version table 440 may correspond generally to an example implementation of the version table 164 (shown in FIG. 1). In some implementations, the V1 version table 440 may include multiple entries, where each entry represents a different address in a volume. Further, in some implementations, each entry of the V1 version table 440 may be initially empty, and may be populated when a data unit is written to the address represented by that entry.

Referring again to FIG. 3, decision block 345 may include determining whether a trigger event for a snapshot has been detected. Upon a negative determination (“NO”), the process 300 may return to block 310 (e.g., to continue receiving writes of data units).

Referring now to FIG. 4B, shown is an example in which a second write command 412 is received prior to capturing the first snapshot, but after receiving the first write command 410 (shown in FIG. 4A). In the example shown in FIG. 4B, the controller receives the second write command 412 to write the data unit “B” to an address “4” in the volume. In response to the second write command 412, the controller identifies the entry “4” (i.e., the entry that is indexed to the write address “4”) in the base table 430, and populates the entry “4” of the base table 430 with an indication of the current snapshot version “V1.” The controller stores the data unit “B” in the location “03” in physical storage 450. Further, the controller populates the entry “4” of the V1 version table 440 with a pointer to the physical location “03.” As shown in FIG. 4B, the controller also populates the entry “4” of the V1 version table 440 with the reference count equal to “1.”

Referring again to FIG. 3, if it is determined at decision block 345 that a trigger event for a snapshot has been detected (“YES”), the process 300 may continue at block 350, including creating a snapshot table as a copy of the base volume table. Block 355 may include, for each entry in the current version table, incrementing the reference count by one. Block 360 may include incrementing the version number by one. Block 365 may include creating a new version table associated with the incremented version number. After block 365, the process 300 may return to block 310 (e.g., to continue receiving writes of data units).

Referring now to FIG. 4C, shown is an example in which a first snapshot trigger 414 is detected after receiving the second write command 412 (shown in FIG. 4B). In the example shown in FIG. 4C, the controller detects the first snapshot trigger 414, and in response sets (e.g., increments) the current snapshot version to “V2” (e.g., in the current version data structure 420). The controller creates a V2 version table 442 (i.e., a version table associated with the current snapshot version “V2”). Further, the controller generates the V1 snapshot table 432 by copying the current base table 430 (i.e., the base table 430 that exists during the copy).

As shown in FIG. 4C, the entries “1” and “4” of the V1 snapshot table 432 are populated with the same indications of snapshot versions (e.g., “V1”) that were populated into the entries “1” and “4” of the base table 430 (i.e., in response to the write commands 410 and 412). Accordingly, because the entry “1” of the V1 snapshot table 432 is now referenced by entries in the base table 430 and the V1 snapshot table 432, the reference count in entry “1” of the V1 version table 440 is set (i.e., incremented) to “2.” Similarly, the reference count in entry “4” of the V1 version table 440 is also set to “2.”

In some implementations, the V1 snapshot table 432 may be a static data structure that duplicates the state of the base table 430 at a particular point in time (i.e., upon detecting the first snapshot trigger 414). The V1 snapshot table 432 may correspond generally to an example implementation of the snapshot table 163 (shown in FIG. 1). Further, the V2 version table 442 may correspond generally to an example implementation of the version table 164 (shown in FIG. 1). As shown in FIG. 4C, the V2 version table 442 may include multiple entries, where each entry represents a different address in a volume. In some implementations, each entry of the V2 version table 442 may be initially empty, and may be populated when a data unit is written to the address represented by that entry.

In some implementations, the snapshot trigger 414 may be an event (also referred to herein as a “trigger event”) that causes the capture of a new snapshot. For example, a trigger event may be a user command to initiate the snapshot capture, a scheduled initiation of the snapshot capture, the expiration of a periodic timer, and so forth. Other examples or combinations of trigger events are possible.

Referring now to FIG. 4D, shown is an example in which a third write command 416 is received after capturing the first snapshot (e.g., as illustrated in FIG. 4C). In the example shown in FIG. 4D, the controller receives the third write command 416 to write the data unit “C” to an address “2” in the volume. In response to the third write command 416, the controller reads the current version data structure 420 to determine the current snapshot version “V2.” The controller then populates the entry “2” of the base table 430 with an indication of the current snapshot version “V2.”

As shown in FIG. 4D, the controller stores the data unit “C” in the location “01” in physical storage 450. Further, the controller populates the entry “2” of the V2 version table 442 with a pointer to the physical location “01.” The controller also populates the entry “2” of the V2 version table 442 with the reference count equal to “1.” In some implementations, the V1snapshot table 432 is not updated to reflect any write commands that are received after the current snapshot version is incremented to “V2.”

Referring now to FIG. 4E, shown is an example in which a second snapshot trigger 417 is detected after receiving the third write command 416 (shown in FIG. 4D). In the example shown in FIG. 4E, the controller detects the second snapshot trigger 417, and in response sets (e.g., increments) the current snapshot version to “V3” (e.g., in the current version data structure 420). The controller creates a V3 version table 444, and generates the V2 snapshot table 434 by copying the current base table 430.

As shown in FIG. 4E, the entries “1” and “4” of the V2 snapshot table 434 are populated with the same indications of snapshot version (i.e., “V1”) that were populated into the entries “1” and “4” of the base table 430. Further, the reference counts in entries “1” and “4” of the V1 version table 440 are set (i.e., incremented) to “3,” thereby indicating that these entries “1” and “4” are referenced by three different volume tables (i.e., the base table 430, the V1 snapshot table 432, and the V2 snapshot table 434). Furthermore, the entry “2” of the V2 snapshot table 434 is populated with the same indication of snapshot version (i.e., “V2”) that was populated into the entry “2” of the base table 430. Accordingly, the reference count in entry “2” of the V2 version table 442 is set to “2,” thereby indicating that the entry “2” is referenced by two different volume tables (i.e., the base table 430 and the V2 snapshot table 434).

Referring now to FIG. 4F, shown is an example in which a fourth write command 418 is received after capturing the second snapshot (e.g., as illustrated in FIG. 4E). In the example shown in FIG. 4F, the controller receives the fourth write command 418 to write the data unit to an address “5” in the volume. In response to the fourth write command 418, the controller reads the current version data structure 420 to determine the current snapshot version “V3.” The controller then populates the entry “5” of the base table 430 with an indication of the current snapshot version “V3.” The controller stores the data unit “X” in the location “07” in physical storage 450. Further, the controller populates the entry “5” of the V3 version table 444 with a pointer to the physical location “07.” As shown in FIG. 4F, the controller also populates the entry “5” of the V3 version table 444 with the reference count equal to “1.”

Referring now to FIG. 4G, shown is an example in which a fifth write command 419 is received after receipt of the fourth write command 418. In the example shown in FIG. 4G, the controller receives the fifth write command 419 to write the data unit “Y” to the address “1” in the volume. Note that, as shown in FIG. 4A, the first write command 412 previous wrote the data unit “A” to address “1” in the volume. Accordingly, the fifth write command 419 causes the data unit “Y”to replace or overwrite the data unit “A”in the address “1” of the volume.

In response to the fifth write command 419, the controller reads the current version data structure 420 to determine the current snapshot version “V3.” The controller then overwrites the pervious value of entry “1” of the base table 430 with an indication of the current snapshot version “V3.” The controller stores the data unit “Y” in the location “02” in physical storage 450, and populates the entry “1” of the V3 version table 444 with a pointer to the physical location “02.”

As shown in FIG. 4G, that the entry “1” of the base table 430 references the entry “1” of the V3 version table 444. Accordingly, the controller populates the entry “1” of the V3 version table 444 with the reference count equal to “1,” thereby indicating that the entry “1” of the V3 version table 444 is referenced by a single volume table (i.e., base table 430). Further, the controller modifies the entry “1” of the V1 version table 444 to reduce the reference count from “3” to “2,” thereby indicating that the entry “1” of the V1 version table 444 is now referenced by two different volume tables (i.e., the V1 snapshot table 432, and the V2 snapshot table 434).

Note that the data unit “A” that was previously written to address “1” (and has now been overwritten by data unit “Y”) remains stored in location “05” of the physical storage 450. Accordingly, the first snapshot (i.e., snapshot version “V1” that is recorded by the combination of the V1 snapshot table 432 and the V1 version table 440) continues to correctly reference the stored data unit “A,” and can therefore be used to restore or reconstruct the first snapshot. Similarly, the second snapshot (i.e., snapshot version “V2” that is recorded by the combination of the V2 snapshot table 434 and the V2 version table 442) also continues to correctly reference the stored data unit “A,”and can therefore be used to restore or reconstruct the second snapshot.

Referring now to FIG. 4H, shown is an example in which the stored data unit “B” is moved 460 from location “03” to “06” (in physical storage 450). For example, the move 460 may be caused by a defragmentation process of the physical storage 450, a failure of a storage device included in the physical storage 450, and so forth. As shown in FIG. 4H, in response to the move 460, the controller accesses the entry “04” in the V1 version table 440, and replaces the pointer to location “03” with a pointer to location “06.” Accordingly, the move 460 only requires updating a single version table (i.e., V1 version table 440), and does not require any changes to the volume tables (i.e., base table 430, V1 snapshot table 432, and V2 snapshot table 434) or the remaining version tables (i.e., V2 version table 442 and V3 version table 444). In this manner, some implementations may reduce the amount of processing and data transfer required to maintain accurate snapshots.

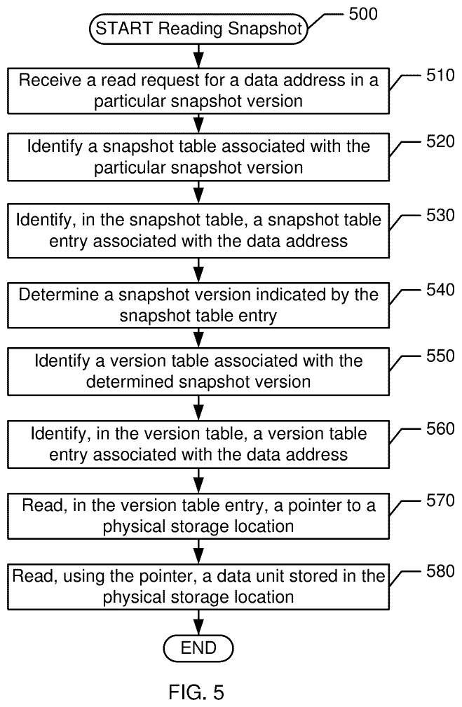

### FIG. 5—Example Process for Reading Snapshot Data

FIG. 5 shows an example process 500 for reading snapshot data, in accordance with some implementations. For the sake of illustration, details of the process 500 may be described below with reference to FIGS. 1-4H, which show examples in accordance with some implementations. However, other implementations are also possible. In some examples, the process 500 may be performed using the storage controller 110 (shown in FIG. 1). The process 500 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Block 510 may include receiving a read request for a data address in a snapshot version. Block 520 may include identifying a snapshot table associated with the particular snapshot version. Block 530 may include identifying, in the snapshot table, a snapshot table entry associated with the data address. Block 540 may include determining a snapshot version indicated by the snapshot table entry.

Block 550 may include identifying a version table associated with the determined snapshot version. Block 560 may include identifying, in the version table, a version table entry associated with the data address. Block 570 may include reading, in the version table entry, a pointer to a physical storage location. Block 580 may include reading, using the pointer, a data unit stored in the physical storage location.

For example, referring to FIG. 4H, the controller receives a first query or request (not shown in FIG. 4H) to read address “1” as recorded in snapshot version “V2.” In response to the first query, the controller accesses entry “1” of the V2 snapshot table 434 (i.e., the snapshot table corresponding to the requested snapshot version “V2”), and reads the version identifier “V1” stored in the entry “1” of the V2 snapshot table 434. Further, the controller accesses entry “1” of the V1 version table 440 (i.e., the version table corresponding to the version identifier “V1”), and reads the pointer “05” stored in the entry “1” of the V1 version table 440. The controller then uses the pointer “05” to read the data unit “A” (stored in location “05” of the physical storage 450), and returns the data unit “A”as a result of the first query.

In another example, still referring to FIG. 4H, the controller receives a second query or request (not shown in FIG. 4H) to read address “2” as recorded in snapshot version “V2.” In response to the second query, the controller accesses entry “2” of the V2 snapshot table 434, and reads the version identifier “V2” stored in the entry “2” of the V2 snapshot table 434. Further, the controller accesses entry “2” of the V2 version table 442 (i.e., the version table corresponding to the version identifier “V2”), and reads the pointer “01” stored in the entry “2” of the V2 version table 442. The controller then uses the pointer “01” to read the data unit “C” (stored in location “1” of the physical storage 450), and returns the data unit “C” as a result of the second query.

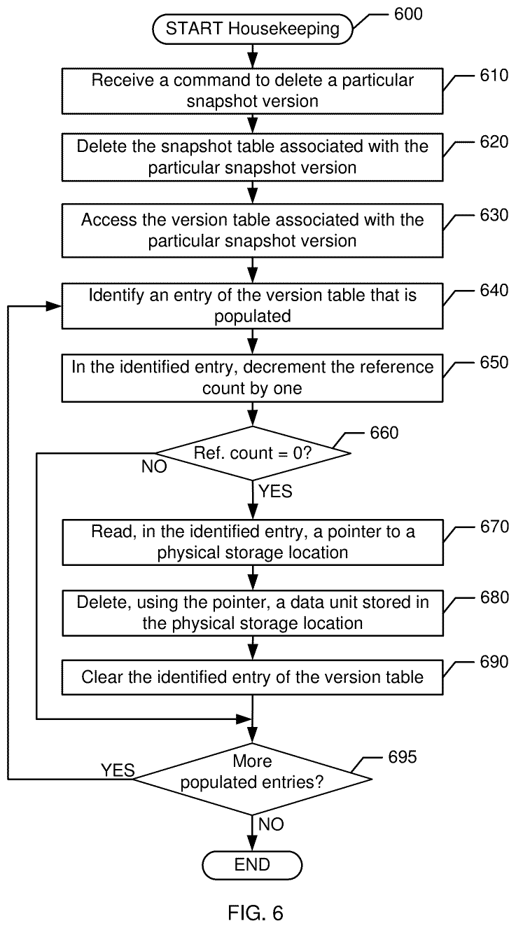

### FIG. 6—Example Process for Housekeeping

FIG. 6 shows an example process 600 for housekeeping, in accordance with some implementations. For the sake of illustration, details of the process 600 may be described below with reference to FIGS. 1-4H, which show examples in accordance with some implementations. However, other implementations are also possible. In some examples, the process 600 may be performed using the storage controller 110 (shown in FIG. 1). The process 600 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Block 610 may include receiving a command to delete a particular snapshot version. Block 620 may include deleting the snapshot table associated with the particular snapshot version. For example, referring to FIG. 4H, the controller receives a command or request (not shown in FIG. 4H) to delete snapshot version “V2.” In response to the command, the controller deletes the V2 snapshot table 434 (i.e., the snapshot table corresponding to the requested snapshot version “V2”).

Referring again to FIG. 6, block 630 may include accessing the version table associated with the particular snapshot version. Block 640 may include identifying an entry of the version table that is populated. Block 650 may include, in the identified entry, decrementing the reference count by one. For example, referring to FIG. 4H, the controller accesses the V2 version table 442 (i.e., the version table corresponding to snapshot version “V2”). Further, the controller determines that entry “2” is the only populated entry in the V2 version table 442, and in response decrements the reference counter included in the entry “2” of the V2 version table 442.

Referring again to FIG. 6, decision block 660 may include determining whether the reference count (decremented by one at block 650) is equal to zero. Upon a positive determination (“YES”), the process 600 may continue at block 670, include reading, in the identified entry, a pointer to a physical storage location. Block 680 may include deleting, using the pointer, a data unit stored in the physical storage location. Block 690 may include clearing the identified entry of the version table. For example, referring to FIG. 4H, the controller determines whether the reference counter (included in the entry “2” of the V2 version table 442) has a zero value. If so, the controller reads the pointer “01” stored in the entry “2” of the V2 version table 442, and uses the pointer “01” to delete the data unit “C” (stored in location “01” of the physical storage 450). Further, the controller clears or otherwise depopulates the entry “2” of the V2 version table 442.

Referring again to FIG. 6, after block 690, of if it is determined at decision block 660 that the reference count is not equal to zero, the process 600 may continue at decision block 695, including determining whether the version table has any remaining populated entries. Upon a positive determination (“YES”), the process 600 may return to block 640 (i.e., to identify and process another entry of the version table that is populated). Otherwise, if it is determined at decision block 695 that the version table does not have any remaining populated entries (“NO”), the process 600 may be completed.

In some implementations, the housekeeping process 600 may use a reference counter (e.g., included in the entry “2” of the V2 version table 442) to determine whether a stored data unit is no longer referenced by any snapshots, and if so to free the storage space for other uses. In this manner, some implementations may provide efficient housekeeping of storage space, but without having to load and analyze multiple metadata structures to identify stale data units. Accordingly, some implementations may reduce the amounts of processing and networking resources consumed to perform housekeeping of stored data.

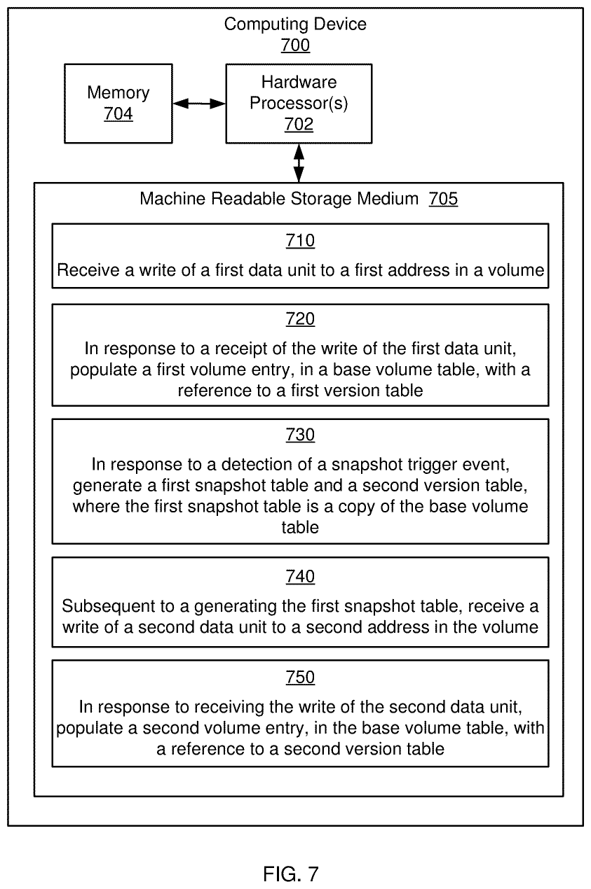

### FIG. 7—Example Computing Device

FIG. 7 shows a schematic diagram of an example computing device 700. In some examples, the computing device 700 may correspond generally to some or all of the storage system 100 (shown in FIG. 1). As shown, the computing device 700 may include a hardware processor 702, a memory 704, and machine-readable storage 705 including instructions 710-750. The machine-readable storage 705 may be a non-transitory medium. The instructions 710-750 may be executed by the hardware processor 702, or by a processing engine included in hardware processor 702.

Instruction 710 may be executed to receive a write of a first data unit to a first address in a volume. Instruction 720 may be executed to, in response to a receipt of the write of the first data unit, populate a first volume entry, in a base volume table, with a reference to a first version table. For example, referring to FIG. 4A, a controller receives a first write command 410 to write the data unit “A” to an address “1” in a volume. In response to the write command 410, the controller reads a current version data structure 420 to determine the current snapshot version “V1.” Further, the controller accesses a base table 430, and identifies an entry that is indexed to the write address “1” (specified in the write command 410). Further, the controller populates the identified entry of the base table 430 with an indication or identifier of the current snapshot version (e.g., “V1”). In some implementations, the identifier of the current snapshot version (in the identified entry of the base table 430) may reference or otherwise identify the V1 version table 440 (i.e., the version table associated with the current snapshot version “V1”).

Instruction 730 may be executed to, in response to a detection of a snapshot trigger event, generate a first snapshot table and a second version table, where the first snapshot table is a copy of the base volume table. For example, referring to FIG. 4C, the controller detects the first snapshot trigger 414, and in response sets (e.g., increments) the current snapshot version to “V2” (e.g., in the current version data structure 420). The controller creates a V2 version table 442 (i.e., a version table associated with the current snapshot version “V2”). Further, the controller generates the V1 snapshot table 432 by copying the current base table 430 (i.e., the base table 430 that exists during the copy).

Instruction 740 may be executed to, subsequent to a generating the first snapshot table, receive a write of a second data unit to a second address in the volume. Instruction 750 may be executed to, in response to receiving the write of the second data unit, populate a second volume entry, in the base volume table, with a reference to a second version table. For example, referring to FIG. 4D, the controller receives the third write command 416 to write the data unit “C” to an address “2” in the volume. In response to the third write command 416, the controller reads the current version data structure 420 to determine the current snapshot version “V2.” The controller then populates the entry “2” of the base table 430 with an indication of the current snapshot version “V2.” Further, the controller stores the data unit “C” in the location “01” in physical storage 450, and populates the entry “2” of the V2 version table 442 with a pointer to the physical location “01.” The controller also populates the entry “2” of the V2 version table 442 with the reference count equal to “1.”

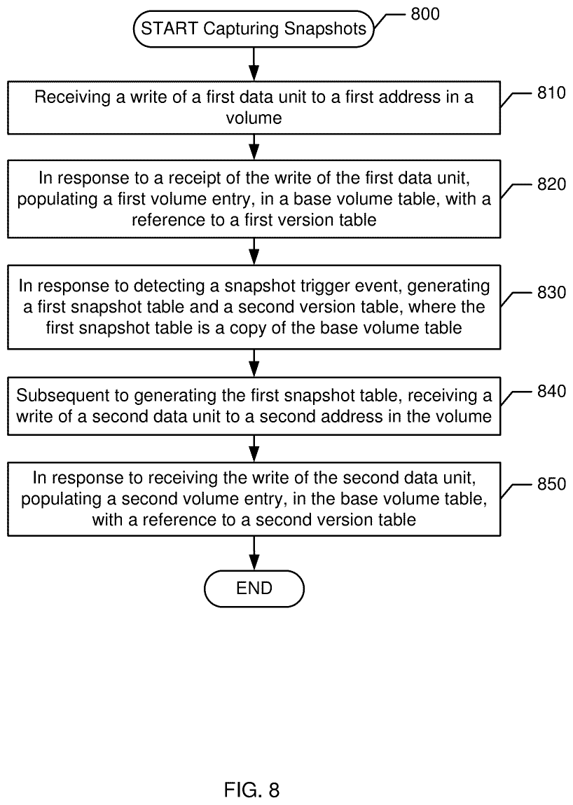

### FIG. 8—Example Process for Capturing Snapshots

FIG. 8 shows an example process 800 for capturing snapshots, in accordance with some implementations. In some examples, the process 800 may be performed using the storage controller 110 (shown in FIG. 1). The process 800 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Block 810 may include receiving, by a controller, a write of a first data unit to a first address in a volume. Block 820 may include, in response to a receipt of the write of the first data unit, the controller populating a first volume entry, in a base volume table, with a reference to a first version table. Block 830 may include, in response to detecting a snapshot trigger event, the controller generating a first snapshot table and a second version table, where the first snapshot table is a copy of the base volume table.

Block 840 may include, subsequent to generating the first snapshot table, the controller receiving a write of a second data unit to a second address in the volume. Block 820 may include, in response to receiving the write of the second data unit, the controller populating a second volume entry, in the base volume table, with a reference to a second version table. Blocks 810-850 may correspond generally to the examples described above with reference to instructions 710-750 (shown in FIG. 7).

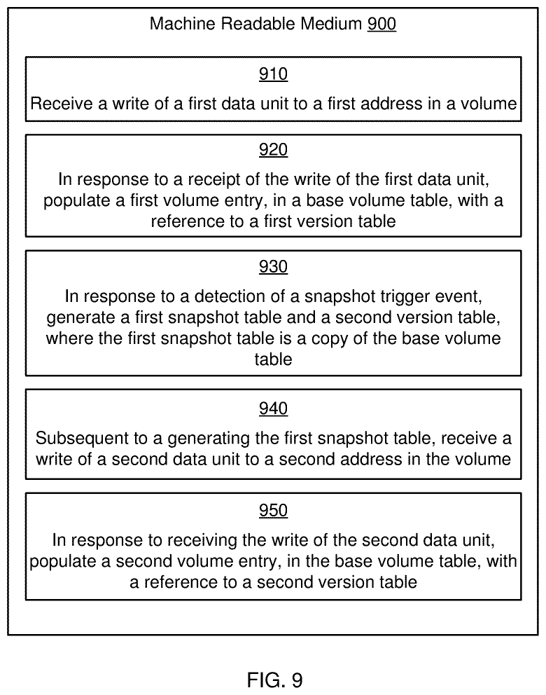

### FIG. 9—Example Machine-Readable Medium

FIG. 9 shows a machine-readable medium 900 storing instructions 910-950, in accordance with some implementations. The instructions 910-950 can be executed by a single processor, multiple processors, a single processing engine, multiple processing engines, and so forth. The machine-readable medium 900 may be a non-transitory storage medium, such as an optical, semiconductor, or magnetic storage medium. The instructions 910-950 may correspond generally to the examples described above with reference to instructions 710-750 (shown in FIG. 7).

Instruction 910 may be executed to receive a write of a first data unit to a first address in a volume. Instruction 920 may be executed to, in response to a receipt of the write of the first data unit, populate a first volume entry, in a base volume table, with a reference to a first version table. Instruction 930 may be executed to, in response to a detection of a snapshot trigger event, generate a first snapshot table and a second version table, where the first snapshot table is a copy of the base volume table.

Instruction 940 may be executed to, subsequent to a generating the first snapshot table, receive a write of a second data unit to a second address in the volume. Instruction 950 may be executed to, in response to receiving the write of the second data unit, populate a second volume entry, in the base volume table, with a reference to a second version table.

### Conclusion

In accordance with implementations described herein, a storage system may use metadata structures including a base volume table, snapshot tables, and version tables. When a data block is written to an address, the corresponding entry of the base volume table may be populated with a reference to a current version table. The corresponding entry of the version table may store a pointer to the physical location of the data block, and may also store a reference count. To generate a snapshot, the base volume may be copied to create a snapshot table, and a new version table may be initialized. The snapshot may be recorded by the combination of the snapshot table and the version table associated with the same snapshot version. Subsequently, if the physical location of the data block is changed, only the version table that includes the pointer to the physical location has to be updated. Accordingly, some implementations may reduce the amount of processing and data transfer required to account for changes to physical locations of stored data (e.g., in comparison to alternative approaches that involve updating the physical location data in multiple metadata structures).

Further, as discussed above with reference to FIG. 6, some implementations may use a reference counter (e.g., included in the entry “2” of the V2 version table 442) to determine whether a stored data unit is no longer referenced by any snapshots, and if so to free the storage space for other uses. In this manner, some implementations may provide efficient housekeeping of storage space, but without having to load and analyze multiple metadata structures to identify stale data units. Accordingly, some implementations may reduce the amounts of processing and networking resources consumed to perform housekeeping of stored data.

Furthermore, in some implementations, the metadata structures may be identified and accessed by snapshot version. As such, if there is a need to update or access the metadata for a specified time frame, it is possible to update or access the corresponding metadata in a relatively simple manner, thereby increasing the efficiency of metadata changes or reads. Additionally, the metadata of stored data may be identified by the time period that it was updated, rather than where the data is stored. Moreover, if there is a need to determine the difference between two volumes, the difference may be determined by comparing only the metadata of the volumes (e.g., without having to access load their respective physical location information into memory).

Note that, while FIGS. 1-9 show various examples, implementations are not limited in this regard. For example, referring to FIG. 1, it is contemplated that the storage system 100 may include additional devices and/or components, fewer components, different components, different arrangements, and so forth. In another example, it is contemplated that the functionality of the storage controller 110 described above may be included in any another engine or software of storage system 100. Other combinations and/or variations are also possible.

Data and instructions are stored in respective storage devices, which are implemented as one or multiple computer-readable or machine-readable storage media. The storage media include different forms of non-transitory memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A computing device comprising:
a processor;
a memory; and
a machine-readable storage storing instructions, the instructions executable by the processor to:
receive a write of a first data unit to a first logical address in a volume;
in response to a receipt of the write of the first data unit, populate a first base entry, in a base table, with a reference to a first version table, wherein the base table comprises a plurality of base entries that are indexed to different logical addresses of the volume, and wherein the first version table comprises a first plurality of version entries that are indexed to different logical addresses of the volume;
in response to a detection of a snapshot trigger event, generate a first snapshot table and a second version table, wherein the first snapshot table is a copy of the base table;
subsequent to a generating the first snapshot table, receive a write of a second data unit to a second logical address in the volume; and
in response to receiving the write of the second data unit, populate a second base entry, in the base table, with a reference to the second version table.

2. The computing device of claim 1, including instructions executable by the processor to:
populate a first version entry, in the first version table, with a first pointer to a physical storage location of the first data unit; and
populate a second version entry, in the second version table, with a second pointer to a physical storage location of the second data unit.

3. The computing device of claim 2, wherein:
the first base entry is indexed to the first logical address;
the second base entry is indexed to the second logical address;
the first version entry is indexed to the first logical address; and
the second version entry is indexed to the second logical address.

4. The computing device of claim 2, including instructions executable by the processor to:
store, in the first version entry of the first version table, a first count of base entries that reference the first version entry; and
store, in the second version entry of the second version table, a second count of base entries that reference the second version entry.

5. The computing device of claim 1, wherein the reference to the first version table is a first snapshot version number, and wherein the reference to the second version table is a second snapshot version number

6. The computing device of claim 5, including instructions executable by the processor to:
in response to detecting the snapshot trigger event, increment a snapshot version counter from the first snapshot version number to the second snapshot version number.

7. The computing device of claim 1, including instructions executable by the processor to:
receive a read request for a logical data address in a specified snapshot version;
identify a particular snapshot table associated with the specified snapshot version;
identify, in the particular snapshot table, a snapshot table entry associated with the logical data address;
determine a particular snapshot version indicated by the snapshot table entry;
identify a particular version table associated with the particular snapshot version;
identify, in the particular version table, a particular version entry associated with the logical data address;
read, in the particular version table entry, a particular pointer to a particular physical storage location; and
read, using the particular pointer, a particular data unit stored in the particular physical storage location.

8. The computing device of claim 1, wherein the second version table comprises a second plurality of version entries that are indexed to different logical addresses of the volume.

9. The computing device of claim 1, wherein:
the first snapshot table is included in a plurality of snapshot tables;
the first version table and the second version table are included in a plurality of version tables; and
a plurality of snapshot versions are recorded as combinations of the plurality of snapshot tables and the plurality of version tables.

10. A method comprising:
receiving, by a controller, a write of a first data unit to a first logical address in a volume;
in response to a receipt of the write of the first data unit, the controller populating a first base entry, in a base table, with a reference to a first version table, wherein the base table comprises a plurality of base entries that are indexed to different logical addresses of the volume, and wherein the first version table comprises a first plurality of version entries that are indexed to different logical addresses of the volume;
in response to detecting a snapshot trigger event, the controller generating a first snapshot table and a second version table, wherein the first snapshot table is a copy of the base table;
subsequent to generating the first snapshot table, the controller receiving a write of a second data unit to a second logical address in the volume; and
in response to receiving the write of the second data unit, the controller populating a second base entry, in the base table, with a reference to the second version table.

11. The method of claim 10, further comprising:
populating a first version entry, in the first version table, with a first pointer to a physical storage location of the first data unit; and
populating a second version entry, in the second version table, with a second pointer to a physical storage location of the second data unit.

12. The method of claim 11, further comprising:
storing, in the first version entry of the first version table, a first count of base entries that reference the first version entry; and
storing, in the second version entry of the second version table, a second count of base entries that reference the second version entry.

13. The method of claim 10, wherein the reference to the first version table is a first snapshot version number, and wherein the reference to the second version table is a second snapshot version number.

14. The method of claim 13, further comprising:
in response to detecting the snapshot trigger event, incrementing a snapshot version counter from the first snapshot version number to the second snapshot version number.

15. The method of claim 13, further comprising:
receiving a read request for a logical data address in a specified snapshot version;
identifying a particular snapshot table associated with the specified snapshot version;
identifying, in the particular snapshot table, a snapshot table entry associated with the data address;
determining a particular snapshot version indicated by the snapshot table entry;
identifying a particular version table associated with the particular snapshot version;
identifying, in the particular version table, a particular version entry associated with the logical data address;
reading, in the particular version table entry, a particular pointer to a particular physical storage location; and
reading, using the particular pointer, a particular data unit stored in the particular physical storage location.

16. A non-transitory machine-readable medium storing instructions that upon execution cause a processor to:
receive a write of a first data unit to a first logical address in a volume;
in response to a receipt of the write of the first data unit, populate a first base entry, in a base table, with a reference to a first version table, wherein the base table comprises a plurality of base entries that are indexed to different logical addresses of the volume, and wherein the first version table comprises a first plurality of version entries that are indexed to different logical addresses of the volume;
in response to a detection of a snapshot trigger event, generate a first snapshot table and a second version table, wherein the first snapshot table is a copy of the base table;
subsequent to a generating the first snapshot table, receive a write of a second data unit to a second logical address in the volume; and
in response to receiving the write of the second data unit, populate a second base entry, in the base table, with a reference to the second version table.

17. The non-transitory machine-readable medium of claim 16, including instructions executable by the processor to:
populate a first version entry, in the first version table, with a first pointer to a physical storage location of the first data unit; and
populate a second version entry, in the second version table, with a second pointer to a physical storage location of the second data unit.

18. The non-transitory machine-readable medium of claim 17, including instructions executable by the processor to:
store, in the first version entry of the first version table, a first count of base entries that reference the first version entry; and
store, in the second version entry of the second version table, a second count of base entries that reference the second version entry.

19. The non-transitory machine-readable medium of claim 16, including instructions executable by the processor to:
in response to detecting the snapshot trigger event, increment a snapshot version counter from a first snapshot version number to a second snapshot version number,
wherein the reference to the first version table is the first snapshot version number, and wherein the reference to the second version table is the second snapshot version number.

20. The non-transitory machine-readable medium of claim 16, including instructions executable by the processor to:
receive a read request for a logical data address in a specified snapshot version;
identify a particular snapshot table associated with the specified snapshot version;
identify, in the particular snapshot table, a snapshot table entry associated with the data address;
determine a particular snapshot version indicated by the snapshot table entry;
identify a particular version table associated with the particular snapshot version;
identify, in the particular version table, a particular version entry associated with the logical data address;
read, in the particular version table entry, a particular pointer to a particular physical storage location; and
read, using the particular pointer, a particular data unit stored in the particular physical storage location.
